(19) United States
(12) Patent Application Publication
(10) Pub. No.: US 2024/0320608 A1
(43) Pub. Date: Sep. 26, 2024

(54) INFORMATION PROCESSING APPARATUS, INFORMATION PROCESSING METHOD, AND STORAGE MEDIUM

(71) Applicant: KABUSHIKI KAISHA TOSHIBA, Tokyo (JP)

(72) Inventors: Ryoko HATAKEYAMA, Arakawa Tokyo (JP); Shizu SAKAKIBARA, Kawasaki Kanagawa (JP); Takufumi YOSHIDA, Funabashi Chiba (JP); Hideyuki AISU, Kawasaki Kanagawa (JP)

(73) Assignee: KABUSHIKI KAISHA TOSHIBA, Tokyo (JP)

(21) Appl. No.: 18/523,165

(22) Filed: Nov. 29, 2023

(30) Foreign Application Priority Data
Mar. 20, 2023 (JP) 2023-044389

(51) Int. Cl. G06Q 10/0835

(52) U.S. Cl. CPC G06Q 10/08355

(57) ABSTRACT

According to one embodiment, an information processing apparatus includes a processor. The processor is configured to create, by replacing a plurality of facilities with some of the plurality of facilities in a facility planning problem for creating a facility plan for operating any facility selected from the plurality of facilities, a partial problem of the facility planning problem, create a condition to be applied to the facility planning problem based on a solution to the created partial problem, and create the facility plan by seeking to solve a facility planning problem to which the created condition is added.

### CROSS-REFERENCE TO RELATED APPLICATIONS

This application is based upon and claims the benefit of priority from Japanese Patent Application No. 2023-044389, filed Mar. 20, 2023, the entire contents of which are incorporated herein by reference.

### FIELD

Embodiments described herein relate generally to an information processing apparatus, an information processing method, and a storage medium.

### BACKGROUND

In general, in a case where a plurality of facilities exist, it is important to select and operate an appropriate facility from among the plurality of facilities, rather than operating all of the plurality of facilities.

Also, rather than operating facilities independently, operating a plurality of facilities in combination may improve evaluation values obtained by evaluation functions such as cost and profit.

Specifically, for example, in truck delivery where trucks are operated as facilities, rather than planning routes of such trucks independently (in sequence) one by one, planning the routes of a plurality of trucks simultaneously enables efficient division of delivery areas, which may increase the number of delivery requests that can be processed (number of deliveries) and decrease the mileage.

Therefore, it is useful to prepare a plan for the selection and operation of the above-mentioned facilities (hereinafter referred to as “facility plan”), and to operate a plurality of facilities according to the facility plan.

In this case, it is necessary to consider an optimization problem to create an appropriate facility plan (hereinafter denoted as “facility planning problem”); however, it is difficult to solve a large-scale facility planning problem, such as creating a long-term facility plan, in practical calculation time. In addition, in a case where a plurality of facilities are combined and operated as described above, it is necessary to consider the effects of the combination, which further increases the calculation time.

Note that approximate solution methods such as heuristics are often used for such large-scale optimization problems. However, in a case where the cost of the facility is high, an error of the solution obtained by the approximate solution method has a large impact; therefore, the approximate solution method is not suitable for the facility planning problem described above.

### BRIEF DESCRIPTION OF THE DRAWINGS

FIG. 1 is a block diagram showing an example of a functional configuration of an information processing apparatus according to an embodiment.

FIG. 2 shows an example of a functional configuration of an input module.

FIG. 3 shows an example of a functional configuration of a partial problem creating module.

FIG. 4 shows an example of a functional configuration of a condition creating module.

FIG. 5 shows an example of a functional configuration of an output module.

FIG. 6 shows an example of a hardware configuration of an information processing apparatus.

FIG. 7 illustrates a mathematical model representing a facility planning problem.

FIG. 8 is a flowchart showing an example of a processing procedure of the information processing apparatus in a first application example.

FIG. 9 is a flowchart showing an example of a processing procedure of the information processing apparatus in a second application example.

### DETAILED DESCRIPTION

In general, according to one embodiment, an information processing apparatus includes a processor. The processor is configured to create, by replacing a plurality of facilities with some of the plurality of facilities in a facility planning problem for creating a facility plan for operating any facility selected from the plurality of facilities, a partial problem of the facility planning problem, create a condition to be applied to the facility planning problem based on a solution to the created partial problem, and create the facility plan by seeking to solve a facility planning problem to which the created condition is added.

Various embodiments will be described with reference to the accompanying drawings.

An information processing apparatus according to the present embodiment is an electronic device (facility plan creating device) configured to select any (appropriate) facility from among a plurality of facilities and to create a facility plan for operating the selected facility.

Note that, in the present embodiment, a facility may be what is operated in a stationary manner, such as a generator, or may be a moving object, such as a truck or a person. Furthermore, selecting a facility may indicate selecting a newly introduced facility or selecting a facility to be operated during a predetermined period (planning period) among facilities already introduced. Furthermore, introducing a facility may indicate purchasing and installing a facility, or using a facility (e.g., borrowing or hiring a facility).

In the present embodiment, a facility plan relating to selecting and operating a facility is described; however, the facility plan may be a plan relating to only selecting a facility.

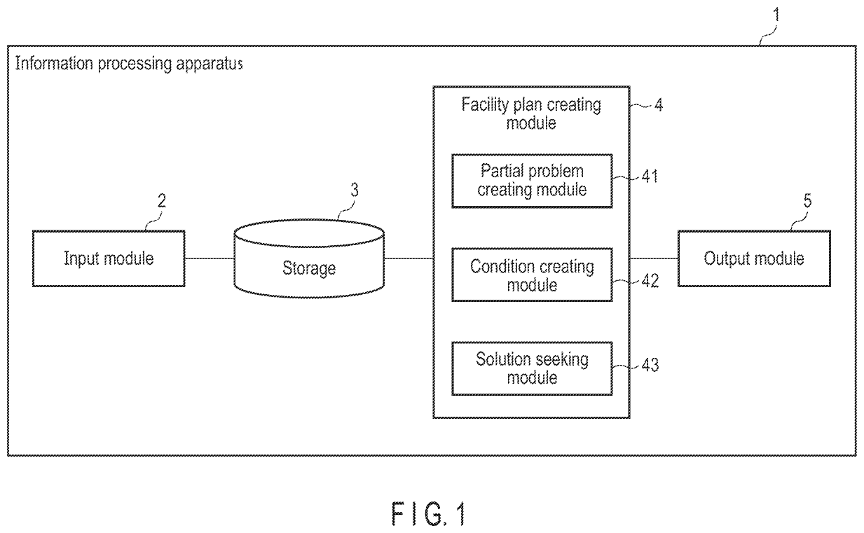

FIG. 1 is a block diagram showing an example of a functional configuration of the information processing apparatus according to the present embodiment. As shown in FIG. 1, an information processing apparatus 1 includes an input module 2, a storage 3, a facility plan creating module 4, and an output module 5.

The input module 2 inputs a facility planning problem (optimization problem) for creating the facility plan described above. The facility planning problem input by the input module 2 is stored in the storage 3.

The facility plan creating module 4 has the function of creating a facility plan using the facility planning problem stored in the storage 3, and includes a partial problem creating module 41, a condition creating module 42, and a solution seeking module 43.

The partial problem creating module 41 creates a partial problem that considers a part of a plurality of facilities from the facility planning problem stored in the storage 3. In the present embodiment, where it is necessary to seek a solution to the facility planning problem in order to create a facility plan for selecting appropriate facilities from a plurality of facilities, the partial problem creating module 41 creates a partial problem of the facility planning problem by replacing a set of facilities in the facility planning problem (hereinafter referred to as an original set) with a partial set representing some of the facilities from the plurality of facilities. In other words, while the facility planning problem is an optimization problem considering the original set, the partial problem is an optimization problem considering a partial set different from the original set.

The condition creating module 42 seeks a solution to the partial problem created by the partial problem creating module 41 and obtains a solution to the partial problem. The condition creating module 42 creates conditions applicable to the facility planning problem based on (information related to) the obtained solution to the partial problem.

Note that processing of the partial problem creating module 41 and processing of the condition creating module 42 may be repeatedly executed while changing the partial set to be considered.

The solution seeking module 43 seeks a solution to the facility planning problem to which the conditions created by the condition creating module 42 have been added, and obtains the solution to the facility planning problem. The solution to the facility planning problem obtained by the solution seeking module 43 corresponds to the facility plan created by the facility plan creating module 4.

The output module 5 outputs the facility plan created by the facility plan creating module 4 as described above.

Here, the facility planning problem input by the input module 2 as described above includes, for example, condition information, evaluation function information, facility information, and operation information.

The condition information indicates constraint conditions of the facility planning problem. The evaluation function information indicates an evaluation function for obtaining evaluation values in a case where each of a plurality of facilities is selected.

The facility information is information related to selecting facilities, and includes, for example, facility resource information and facility partial set information. The facility resource information is information related to resources consumed by selecting facilities. The resources consumed by selecting facilities may include budgets (upper cost limit) for introducing facilities. The facility partial set information is information related to the partial set of facilities described above, and includes, for example, facility ranking information. The facility ranking information indicates a priority order of each partial set of facilities. Note that the partial set of facilities may be configured by one facility or two or more facilities. The facility planning problem may also include a plurality of pieces of facility information.

The operation information is information related to operating the facility and includes, for example, operation resource information. The operation resource information is information related to resources consumed by operating the facility. The resources consumed by operating the facility may include, for example, truck fuel and delivery requests for truck deliveries. Note that the facility planning problem may include a plurality of pieces of operation information.

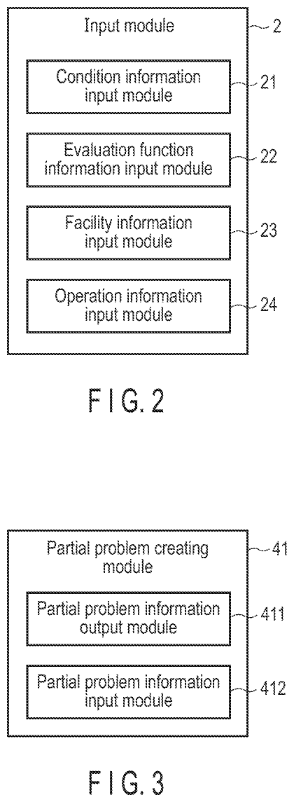

In the present embodiment, the input module 2 shown in FIG. 1 may be configured to include a condition information input module 21 for inputting the above condition information, an evaluation function information input module 22 for inputting evaluation function information, a facility information input module 23 for inputting facility information, and an operation information input module 24 for inputting operation information, as shown in FIG. 2.

Although FIG. 2 shows an example in which the input module 2 includes the condition information input module 21, the evaluation function information input module 22, the facility information input module 23, and the operation information input module 24, at least a part of the condition information input module 21, the evaluation function information input module 22, the facility information input module 23, and the operation information input module 24 may be omitted (that is, the input module 2 may be configured to input a part of the various pieces of information described above).

Note that, although omitted in FIG. 2, the input module 2 may be further configured to include, for example, at least a part of a facility resource information input module for inputting the facility resource information, a facility partial set information input module for inputting the facility partial set information, a facility ranking information input module for inputting the facility ranking information, and an operation resource information input module for inputting the operation resource information.

The partial problem creating module 41 shown in FIG. 1 may also determine a partial set (some of the facilities among the plurality of facilities) to be considered in the partial problem based on the facility partial set information described above. In a case where a plurality of partial problems are created, the partial problem creating module 41 may determine the order in which the partial problems are created (sought to be solved) based on the facility ranking information described above. In addition, the partial problem creating module 41 may create a partial problem for each of the plurality of partial sets.

Furthermore, the partial problem creating module 41 may be configured to include a partial problem information output module 411 and a partial problem information input module 412, as shown in FIG. 3.

The partial problem information output module 411 outputs, for example, at least one of the condition information, the evaluation function information, the facility information, and the operation information included in the facility planning problem described above.

The partial problem information input module 412 inputs information related to creating the partial problem in response to a user operation based on at least one of the condition information, the evaluation function information, the facility information, and the operation information output by the partial problem information output module 411.

According to such partial problem information output module 411 and partial problem information input module 412, it is possible to create partial problems interactively with the user.

Note that a part of the constraint conditions and evaluation functions in the partial problems created by the partial problem creating module 41 may be different from the constraint conditions and evaluation functions in the facility planning problem.

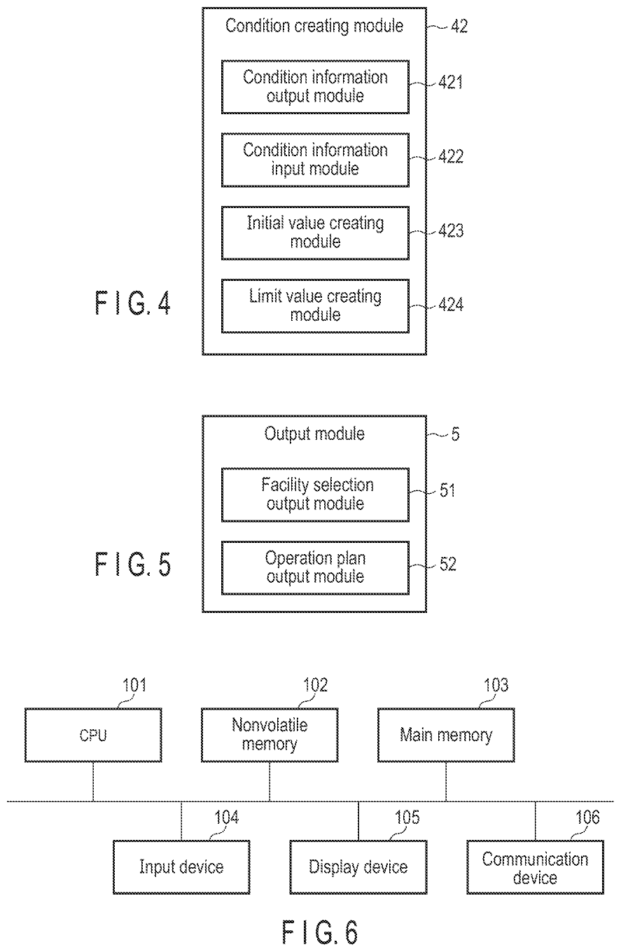

Furthermore, the condition creating module 42 shown in FIG. 1 may be configured to include a condition information output module 421, a condition information input module 422, an initial value creating module 423, and a limit value creating module 424, as shown in FIG. 4.

The condition information output module 421 outputs information related to a solution of a partial problem, which is obtained, for example, by seeking to solve the partial problem created by the partial problem creating module 41.

The condition information input module 422 inputs information related to creating conditions applicable to a facility planning problem in response to a user operation based on the information related to the solution of the partial problem output by the condition information output module 421.

According to such condition information output module 421 and condition information input module 422, conditions applicable to the facility planning problem can be created interactively with the user.

The initial value creating module 423 creates initial values applicable to the facility planning problem based on, for example, the solution to the partial problem created by the partial problem creating module 41.

The limit value creating module 424 creates limit values applicable to the facility planning problem based on, for example, the evaluation values in the partial problems sought to be solved by the condition creating module 42.

That is, in the present embodiment, the solution seeking module 43 seeks to solve the facility planning problem to which the above conditions, initial values, and limit values are added (applied).

Here, as described above, in FIG. 1, the condition creating module 42 seeks to solve the partial problem, and the solution seeking module 43 seeks to solve the facility planning problem. As a method for solving such facility planning problems and partial problems, mathematical calculation solvers such as Gurobi Optimizer or CPLEX may be used, a gradient method, or metaheuristic solution methods such as simulated annealing or genetic algorithm may also be used. In a case where a plurality of pieces of facility information and operation information are given as described above, a plurality of facility planning problems based on each of the pieces of information may be sought to be solved, or a single facility planning problem based on a combination of the information may be solved.

The facility plan (i.e., a solution to the facility planning problem) created by the facility plan creating module 4 described above includes facilities to be selected from the plurality of facilities (i.e., the suitability of selecting each of the plurality of facilities) and an operation plan for the facilities. In this case, the output module 5 shown in FIG. 1 may be configured to include a facility selection output module 51 and an operation plan output module 52, as shown in FIG. 5.

The facility selection output module 51 outputs the facility to be selected from among the plurality of facilities included in the facility plan. The operation plan output module 52 outputs the operation plan included in the facility plan.

In FIG. 5, the output module 5 is described as including the facility selection output module 51 and the operation plan output module 52, but the output module 5 may, for example, be configured to include only the facility selection output module 51. In other words, the output module 5 should be configured to output at least the suitability of each of the plurality of facilities.

In a case where the facility planning problem includes a plurality of pieces of facility information or operation information as described above, the suitability of each of the plurality of facilities based on a plurality of solutions obtained by seeking to solve the facility planning problem for each of the facility information or operation information, statistics of the plurality of solutions, etc., may be output.

Note that, as mentioned above, the partial problem creating module 41 can create a plurality of partial problems. However, the partial problem creating module 41 may not have to create partial problems that consider all partial sets specified by, for example, the facility partial set information, or may create partial problems with different constraint conditions or evaluation functions. Furthermore, the partial problem creating module 41 may create partial problems based on information related to solutions to partial problems that have already been sought to be solved. The condition creating module 42 may not have to seek to solve all of the partial problems created by the partial problem creating module 41. In addition, the condition creating module 42 may seek to solve each of the plurality of partial problems after the plurality of partial problems are created by the partial problem creating module 41, or may seek to solve the partial problem each time the partial problem is created (i.e., the partial problem may be created and sought to be solved repeatedly in a sequential manner).

FIG. 6 shows an example of a hardware configuration of the information processing apparatus 1. As shown in FIG. 6, the information processing apparatus 1 includes a CPU 101, a nonvolatile memory 102, a main memory 103, an input device 104, a display device 105, a communication device 106, etc.

The CPU 101 is a hardware processor that controls the operation of each component in the information processing apparatus 1. The CPU 101 executes various programs that are loaded into the main memory 103 from the nonvolatile memory 102, which is a storage device. The programs executed by the CPU 101 include an operating system (OS) and programs for creating facility plans as described above (hereinafter referred to as “information processing programs”).

The input device 104 is a device configured to input various pieces of information and includes, for example, a mouse and a keyboard. The display device 105 is a device configured to display (output) various pieces of information and includes, for example, a display. The communication device 106 is a device configured to execute, for example, wired or wireless communication with an external device.

Although only the nonvolatile memory 102 and the main memory 103 are shown in FIG. 6, the information processing apparatus 1 may further include other storage devices, such as a hard disk drive (HDD) and a solid state drive (SSD).

In the present embodiment, a part of or all of the input module 2, the facility plan creating module 4, and the output module 5 shown in FIG. 1 are realized by having the CPU 101 shown in FIG. 6 execute an information processing program, that is, by software. This information processing program may be downloaded to the information processing apparatus 1 via a network or distributed by being stored on a storage medium. In addition, a part of or all of the input module 2, the facility plan creating module 4, and the output module 5 may be realized by hardware such as integrated circuits (IC), or by a configuration combining software and hardware.

The storage 3 shown in FIG. 1 is realized by the nonvolatile memory 102 shown in FIG. 6 or other storage devices, etc.

By the way, the present embodiment assumes a case where a facility plan is created such that a higher evaluation value can be obtained by combining and operating a plurality of facilities; however, in a case where, for example, the facility planning problem does not include resources consumed by selecting facilities (facility resources) or resources consumed by operating facilities (operation resources), the partial problem should be created by simply replacing the original set in the facility planning problem with the partial set, as described above.

On the other hand, in a case where the facility planning problem includes facility resources and operation resources, a partial problem may be created and sought solution by eliminating elements related to the resources from the condition information (constraint conditions) and evaluation function information (evaluation function) included in the facility planning problem, or a partial problem may be created and sought solution sequentially (i.e., create and seek solution to partial problems repeatedly) by considering the consumption of facility resources or operation resources (i.e., consumed resources) in partial problems that are already sought solution.

The following is a description of first and second application examples to which the information processing apparatus 1 of the present embodiment is applied.

First, the first application example will be explained. In the first application example, it is assumed that a facility plan is an installation plan for a generator, and that a partial problem is created and sought to be solved by excluding elements related to consumed resources from the condition information and evaluation function information.

Specifically, in the first application example, a generator is installed as a facility and the power generated by the generator is sold in a regulation market (demand-supply adjustment market) and a spot market. The regulation market is a market where regulating power is bought and sold. The regulating power is a power for which power generation capacity equivalent to a contract amount (contracted capacity) in the regulation market is secured on a daily basis, and generated in response to commands from bidders within a range that does not exceed the contract amount. Since the power generation capacity equivalent to the contract amount must be secured at all times, such power generation capacity cannot be used to generate power for trading in other markets such as the spot market.

In addition, the regulating power is defined a time to change the output from the receipt of a command to a command value (hereinafter referred to as “response time”). Generally, since it takes time for a stopped generator to respond, in a case where a specified response time is short, even if the stopped generator is operated after receiving a command, the output cannot be changed to the command value, and the regulating power cannot be supplied in the specified response time.

Considering the above circumstances, the generator should always be operated, and furthermore, instead of operating the generator at a maximum power generation capacity (rated output), the generator should be operated minus an amount equivalent to the regulating power. This makes it possible to supply the regulating power in a short response time when the command is received.

Here, a generator generally has the best fuel efficiency when operated at its rated output, and the fuel efficiency deteriorates as the output amount decreases. However, fuel efficiency and the degree to which the fuel efficiency deteriorates vary depending on the type of generator. Therefore, in a case where a plurality of generators are operated in combination, instead of securing the regulating power for each generator, it is considered that costs can be reduced by, for example, allocating the regulating power to the generator with relatively high fuel efficiency even in a case where the output amount is low.

That is, the object of the generator installation planning problem (optimization problem for creating a generator installation plan) in the first application example is to select a generator to be installed from a set of multiple types of generators with different specifications to minimize the cost.

A mathematical model representing the generator installation planning problem in the first application example is described below. In the mathematical model described below, it is assumed that a generator that is stopped cannot supply regulating power.

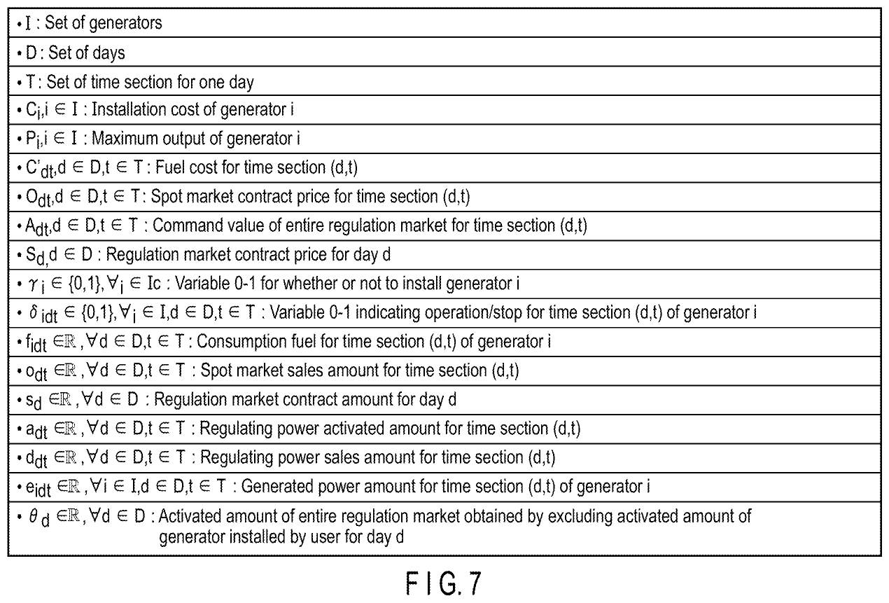

FIG. 7 shows the definitions of symbols describing the mathematical model. In FIG. 7, a subscript i represents a generator, d represents a date, and t represents a time section. For example, Ci and Pi, etc., in FIG. 7 correspond to facility information, and C′_{dt}, O_{dt}, A_{dt}, etc., correspond to operation information.

The following equations (1) to (5) are part of the constraint conditions indicated by the condition information included in the generator installation planning problem.

$$\begin{matrix}{δ}_{idt} \leq {γ}_{i} & ∀ i ∈ I , & d ∈ D , & t ∈ T\end{matrix} \qquad Equation ( 1 )$$

$$\begin{matrix}{\sum }_{i ∈ I} {e}_{idt} = {o}_{dt} + {a}_{dt} & ∀ d ∈ D , & t ∈ T\end{matrix} \qquad Equation ( 2 )$$

$$\begin{matrix}{\sum }_{i ∈ I} {P}_{i} {δ}_{idt} \geq {o}_{dt} + {s}_{d} & ∀ d ∈ D , & t ∈ T\end{matrix} \qquad Equation ( 3 )$$

$$\begin{matrix}{s}_{{d}^{\geq }} {a}_{dt} & ∀ d ∈ D , & t ∈ T\end{matrix} \qquad Equation ( 4 )$$

$$\begin{matrix}{a}_{dt} \geq {A}_{dt} - {θ}_{d} & ∀ d ∈ D , & t ∈ T\end{matrix} \qquad Equation ( 5 )$$

Equation (1) represents a constraint condition that only installed generators can operate. Equation (2) represents a constraint condition that the generated power can be sold in the spot market or used to activate the regulating power. Equation (3) represents a constraint condition that the power generation capacity of an operating generator can cover the amount of power sold in the spot market and the contract amount of the regulation market. Equation (4) represents a constraint condition that the activated amount of regulating power does not exceed the contract amount in the regulation market. Equation (5) represents a constraint condition that the activated amount is a value obtained by subtracting activated amount of other bidders from a total command value of regulating power.

Equation (6) below is an evaluation function indicated by the evaluation function information included in the generator installation planning problem.

$${\sum }_{i ∈ I} {C}_{i} {γ}_{i} + {\sum }_{i ∈ I , d ∈ D , t ∈ T} {C}_{dt}^{′} {f}_{idt} - {\sum }_{d ∈ D , t ∈ T} {O}_{dt} {o}_{dt} - {\sum }_{d ∈ D , t ∈ T} {d}_{dt} - {\sum }_{d ∈ D} {S}_{d} {s}_{d} \qquad Equation ( 6 )$$

Equation (6) shows an example of an evaluation function that can obtain costs as an evaluation value. Equation (6) shows, in order from the first term, an installation cost of the generator, a fuel cost, sales amount of the spot market, sales amount for the activation of the regulation market, and contract amount of the relevant regulation market.

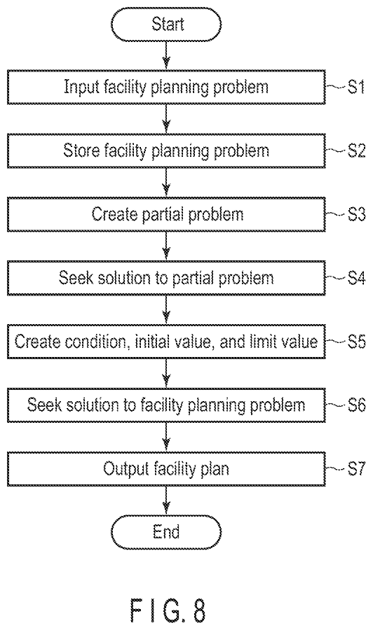

An example of a processing procedure of the information processing apparatus 1 in the first application example is described below with reference to a flowchart in FIG. 8.

First, the input module 2 inputs a generator installation planning problem as the facility planning problem (step S1). In this case, the input module 2 (the condition information input module 21 and the evaluation function information input module 22) inputs condition information indicating constraint conditions such as the above equations (1) to (5) and evaluation function information indicating evaluation functions such as equation (6). In addition, the input module 2 (the facility information input module 23) inputs facility information such as a set of generators, the installation cost of each generator, and performance values such as power generation efficiency with respect to maximum and minimum load and load factor. Furthermore, the input module 2 (facility partial set information input module) inputs a partial set configured by one generator as facility partial set information. In addition, the input module 2 (the operation information input module 24) inputs fuel costs and spot market contract prices, etc., for each time section as operation information. Furthermore, the input module 2 (operation resource information input module) inputs the command value and activation amount, etc., for the entire regulation market as operation resource information.

The generator installation planning problem (the installation planning problem including the condition information, the evaluation function information, the facility information, and the operation information, etc.) input in step S1 is stored in the storage 3 (step S2).

Next, the partial problem creating module 41 creates a partial problem based on the facility partial set information described above, for example, considering only one generator (step S3). The partial problem created in this manner corresponds to a problem of determining whether or not it is appropriate to install a generator i in the case where only one generator i is independently operated (i.e., suitability of the installation of the generator i). In other words, the partial problem is created by replacing a set of generators i in the mathematical model representing the generator installation planning problem described above with a set configured only by the generator i.

Here, the present embodiment is premised on an idea that if the introduction (selection) of the facility is appropriate when the facility is underestimated in the partial problem, it can be determined that the introduction of the facility is appropriate in the installation planning problem as well. Note that, in the present embodiment, it is assumed that operating a facility independently in a case where the evaluation improves (or at least does not decline) by operating multiple facilities in combination corresponds to the underestimation of the facility as described above. That is, in the case of operating the facility independently (i.e., evaluating independently), in a case where there is an element that could result in an overestimation, a partial problem from which the element is eliminated is created.

In this case, for example, the partial problem information output module 411 outputs conditions and evaluation functions that span among a plurality of generators including the generator i, and conditions and evaluation functions that have little relationship with the generator i, etc. Note that the conditions and evaluation functions that have little relationship with the generator i include, for example, conditions and terms of evaluation functions in which the generator i does not explicitly appear (i.e., does not include a subscript of the generator i).

Specifically, among the above equations (1) to (5), for example, θ_{d} in equation (5) is the activated amount of the entire regulation market excluding the activated amount of the generator installed by the user, and the actual generated power amount of the generator i is a value obtained by subtracting the sum of θ_{d} and the generated power amount of other generators installed by the user from a command value A_{dt} of the entire market. However, since only the generator i is considered in the partial problem, and the activated amount of the generator in a case where the user installs a generator other than the generator i is ignored, the activated amount of the generator i may become larger than the actual amount. In addition, since equation (5) is a constraint condition for considering the fuel cost according to the activated amount of the generator i, in a case where equation (5) is not adopted as the constraint condition, there is a possibility that it may violate the underestimation of the facility described above (i.e., it may be an overestimation).

In this case, by outputting the above equation (5) (displaying it on the display device 105), the partial problem information input module 412 inputs, as information related to the creation of the partial problem, adopting equation (5) as a constraint condition for the partial problem, for example, in response to a user operation. According to this, the partial problem creating module 41 can create a partial problem including equation (5) as a constraint condition based on the input information related to the creation of the partial problem. Note that, although the case of creating a partial problem including equation (5) as a constraint condition is described here, depending on the constraint condition, information related to creating a partial problem that does not adopt the constraint condition may be input by the partial problem information input module 412, and a partial problem that does not include the constraint condition may be created.

Furthermore, the partial problem information output module 411 may output equation (6). Here, for example, since the value of a fourth term of equation (6) may become larger than a profit obtained according to the actual activated amount, the fourth term of equation (6) is considered as an element that may result in overestimation. In this case, the partial problem information input module 412 inputs, as information related to the creation of the partial problem, that, for example, the sales amount for the activation of the regulation market in the fourth term of equation (6) is not to be included in the evaluation function, in response to a user operation. According to this, the partial problem creating module 41 can create a partial problem based on the evaluation function that does not include the fourth term of equation (6).

Note that, although it has been explained here that a partial problem is created based on the information related to the creation of a partial problem input by the partial problem information input module 412, the partial problem creating module 41 may automatically create a partial problem that excludes conditions and evaluation functions, etc., that have little relationship to the generator i described above.

Next, the condition creating module 42 seeks to solve the partial problem created in step S3 (step S4). Note that, in a case where the partial problem is sought to be solved, suitability of the installation of the generator i described above is determined (i.e., whether or not it is appropriate to install the generator i).

After the processing of step S4 is executed, the condition creating module 42 creates conditions, initial values, and limit values to be applied to the generator installation planning problem based on the information related to the solution to the partial problem (step S5).

Specifically, the information related to the solution to the partial problem includes the solution to the partial problem (i.e., the suitability of the installation of the generator) and the evaluation values (evaluation function values) in the partial problem. In this case, for example, for the generator i whose installation is determined as appropriate in the partial problem, the condition creating module 42 creates a condition (Yᵢ=1) that states that the installation is appropriate in the generator installation planning problem (original problem). In addition, for the generator i that was determined to be inappropriate for installation in the partial problem, the condition creating module 42 (initial value creating module 423) creates an initial value (Yᵢ=0) that states that the installation is inappropriate. Furthermore, the condition creating module 42 (limit value creating module 424) creates the sum of the evaluation values in the partial problem as the limit value (upper cost limit). The reason why the sum of the evaluation values in the partial problem is used as the limit value is not only that the activated amount of the regulating power (i.e., fuel cost) is overestimated in the partial problem and the sales amount for the activation is not considered, but also that, as mentioned above, since it is possible to secure the power generation capacity for the regulating power efficiently by operating a plurality of generators in combination (i.e., costs can be reduced more), the original problem has a solution whose evaluation value is smaller than the sum of the evaluation values of the partial problem.

Note that, in a case where a plurality of partial problems are created in step S3, the conditions, initial values, and limit values may be created based on the solution of each partial problem and the statistics of the evaluation values in the partial problem.

Furthermore, the condition information output module 421 may output solutions to the partial problems and the evaluation values (or statistics) in the partial problems, and the condition information input module 422 may input information related to the creation of conditions, initial values, and limit values applicable to the generator installation planning problem in response to a user operation, so that the condition creating module 42 may create conditions, initial values, and limit values based on the input information.

Note that, although it is explained here that the conditions, initial values, and limited values are created, if it is possible to reduce the range of searching for the solution to the generator installation planning problem (facility planning problem) as described later, at least one of the conditions, initial values, and limit values may be omitted.

The solution seeking module 43 seeks to solve the generator installation planning problem (facility planning problem) to which the conditions, initial values, and limit values created in step S5 are added (step S6). As a result, for example, compared to the case where the generator installation planning problem input in step S1 is solved as it is, it is possible to reduce the range for searching for a solution, and reduce the time required for seeking the solution (i.e., solution seeking can be performed at high speed). Specifically, each time a condition that the installation of one generator is appropriate is added, the range for searching for a solution can be reduced to ½.

Note that, in a case where the processing of step S6 is executed, a generator installation plan (facility plan) is created, and the output module 5 outputs the generator installation plan (step S7).

Here, the generator installation plan (i.e., the solution to the generator installation planning problem) includes the suitability of the installation of each generator (Yᵢ) and the operation plan of the generator. In this case, the suitability of the installation of each generator is output by the facility selection output module 51, and the operation plan of the generator is output by the operation plan output module 52.

In addition, in a case where a plurality of pieces of facility and operation information are included in the facility planning problem, the suitability of the installation of the generator (facility) based on multiple solutions obtained by seeking to solve the facility planning problem for each facility and operation information, and statistics related to the multiple solutions may also be output.

In addition, here, for example, it is assumed that the fuel cost, the contract price and contract amount of an electricity market, the command value of the regulating power, etc., are fixed; however, in a case where, for example, a plurality of pieces of operation information based on a plurality of scenarios with different confidence levels of estimation is input, the facility planning problem may be sought to be solved for each of the operation information, and statistics of an expected value of the suitability of the installation of each generator, etc., may be output based on the confidence level.

As described above, in the first application example, the information processing apparatus 1 operates to create a partial problem by ignoring the profit of resource consumption and underestimate the solution to the partial problem.

Note that, in the first application example, although it is assumed that the facility planning problem includes resources consumed by selecting facilities and resources consumed by operating facilities, in a case where the resources are not included, the processing of creating the partial problem shall be executed by replacing the original set in the facility planning problem with the partial set in step S3 shown in FIG. 8.

Next, the second application example is described. In the second application example, a case in which the facility plan is a truck delivery plan is assumed, and the partial problems are created and sought to be solved sequentially, taking into account the consumption of facility resources or operation resources in the partial problems already sought to be solved.

Specifically, in the second application example, a truck is borrowed, and the truck is used to deliver packages from a depot to each location. Note that a location at which a package is to be delivered and the amount of package to be delivered to that location (i.e., the demand at that location) are referred to as a delivery request. The maximum loading capacity (capacity) of a truck is defined, and in truck delivery, reward can be earned by processing delivery requests within a range where the sum of demands does not exceed the capacity. Note that the fuel cost needed for truck delivery depends on the mileage traveled by the truck.

Here, if the cost is obtained by subtracting the sum of rewards obtained by processing delivery requests from the sum of truck rental fees and fuel costs, the object of the truck delivery planning problem (optimization problem for creating a truck delivery plan) in the second application example is to select the number of trucks to be borrowed so as to minimize costs (i.e., maximize profit obtained by subtracting the sum of truck rental fees and fuel costs from the sum of rewards). In other words, the truck delivery planning problem is a problem of finding the minimum number of trucks needed for processing all of the sets of delivery requests. However, in a case where the rental fee for the minimum number of trucks exceeds the budget ceiling, or in a case where there are routes that are not worth the reward due to too long mileage, the truck delivery planning problem is a problem of finding the most profitable combination in consideration of the delivery requests and routes that are worth the number of trucks possible within the budget and the reward.

Note that, in the truck delivery in the second application example, it is necessary to select the number of trucks to borrow, assign delivery requests to the borrowed trucks, and determine the order in which the delivery requests are processed (i.e., the route around the assigned locations). When delivery requests are assigned to trucks in order and routes are determined, routes that are closer to the depot or to locations with higher rewards are preferentially selected, and thus more efficient routes are determined if deliveries by multiple trucks are planned simultaneously, which may increase the total number of delivery requests that can be processed and decrease the mileage.

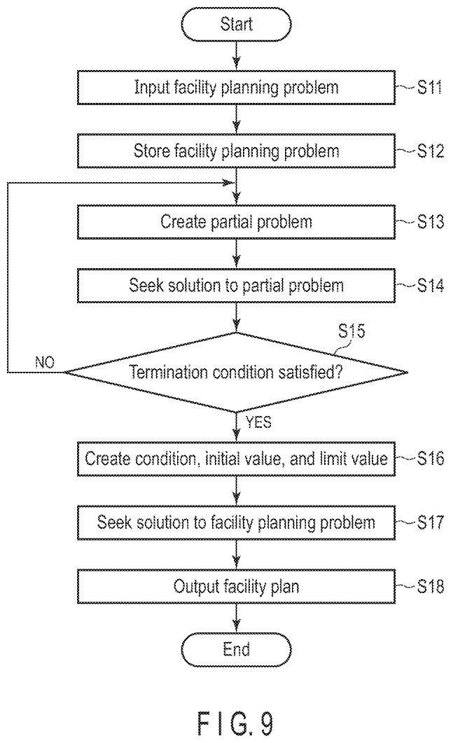

In the following, an example of the processing procedure of the information processing apparatus 1 in the second application example is described with reference to a flowchart in FIG. 9.

First, the input module 2 inputs a truck delivery planning problem as a facility planning problem (step S11). Specifically, the input module 2 (the condition information input module 21 and the evaluation function information input module 22) inputs, for example, condition information indicating the constraint conditions require all borrowed trucks must arrive at and depart from the depot, etc., and evaluation function information indicating an evaluation function that can obtain the above-described cost as the evaluation value. In addition, the input module 2 (the facility information input module 23) inputs performance values, etc., such as rental fee and capacity for each truck, as the facility information. Furthermore, the input module 2 (the facility resource information input module) inputs budgets for borrowing trucks as the facility resource information. In addition, the input module 2 (the facility partial set information input module) inputs a partial set configured by one truck each as the facility partial set information. In addition, the input module 2 (the facility ranking information input module) inputs a priority order of each truck assigned based on the ratio of the amount of rental fee to capacity in ascending order as the facility ranking information. Furthermore, the input module 2 (the operation information input module 24) inputs as operation information fuel costs required for trucks to travel between each location, the location and demand in each delivery request (the location where a package is to be delivered in each delivery request and the quantity of the package to be delivered), and the reward obtained by processing each delivery request, etc. In addition, the input module 2 (the operation resource information input module) inputs a set of delivery requests, etc., as the operation resource information.

The truck delivery planning problem (facility planning problem including condition information, evaluation function information, facility information, and operation information, etc.) input in step S11 is stored in the storage 3 (step S12).

Next, the partial problem creating module 41 selects one truck whose rental fee is inexpensive for its capacity based on the facility ranking information, and creates a partial problem that considers only one such selected truck (hereinafter denoted as “target truck”) (step S13). The partial problem created in this manner corresponds to a problem of determining whether or not it is appropriate to process some requests out of the set of delivery requests by the target truck (i.e., suitability of borrowing the target truck).

The condition creating module 42 seeks to solve the partial problem created in step S13 (step S14).

Note that, when the processing of step S14 is executed, a value obtained by subtracting the rental fee of the target truck described above from the budget is set as the remaining budget (new budget), and a set that is obtained by excluding the delivery requests assigned to the target truck from the set of delivery requests is set as the new set of delivery requests.

Next, it is determined whether or not the conditions for terminating the creation of the partial problem (hereinafter referred to as “termination conditions”) are satisfied (step S15). Note that the termination conditions include, for example, determining that borrowing a truck is inappropriate in the partial problem (hereinafter referred to as “first termination condition”), that a rental fee of the next truck to be selected exceeds the remaining budget (hereinafter referred to as “second termination condition”), and that there are no delivery requests to be assigned to a truck (i.e., a set of new delivery requests is an empty set) (hereinafter referred to as “third termination condition”).

In a case where it is determined that all of the first to third termination conditions are not satisfied (“NO” in step S15), the processing returns to step S13 and is repeated. That is, in the second application example, considering that resources (in this case, budget and delivery requests, etc.) are consumed by sequentially selecting or operating the plurality of facilities, processing is executed in a manner that a plurality of partial problems reflecting the consumed resources are repeatedly created and sought to be solved.

On the other hand, in a case where it is determined that at least one of the first to third termination conditions is satisfied (“YES” in step S15), the condition creating module 42 creates conditions, initial values and limit values to be applied to the truck delivery planning problem based on information related to the solution to the partial problem (for example, suitability of borrowing a truck and evaluation values in the partial problem, etc.) (step S16).

Specifically, for example, in a case where it is determined that the first termination condition is satisfied, the condition creating module 42 creates a condition that borrowing is appropriate in the truck delivery planning problem (original problem) for the trucks that have been determined to be appropriate for borrowing in each partial problem by repeatedly executing steps S13 and S14 as described above. In addition, the condition creating module 42 (the initial value creating module 423) creates initial values that indicate that borrowing is inappropriate for trucks other than those determined to be appropriate for borrowing in each partial problem. Furthermore, the condition creating module 42 (the limit value creating module 424) creates the sum of the evaluation values in each partial problem as the limit value.

On the other hand, in a case where, for example, the second or third termination condition is determined to be satisfied, the condition creating module 42 (the initial value creating module 423) creates an initial value that borrowing is appropriate in the truck delivery planning problem for the trucks determined to be appropriate for borrowing in each partial problem. In addition, for trucks other than those determined to be appropriate for borrowing in each partial problem, the condition creating module 42 creates a condition that borrowing is inappropriate in the truck delivery planning problem. Furthermore, the condition creating module 42 (the limit value creating module 424) creates the sum of the evaluation values in each partial problem as the limit value.

Note that, in a case where it is determined that both the first termination condition and the second or third termination condition are satisfied, the processing in the case where the first termination condition is satisfied shall be executed (i.e., the first termination condition takes precedence over the second and third termination conditions).

In addition, the condition information output module 421 may output the solution to the partial problem and the evaluation value in the partial problem, the condition information input module 422 may input information related to the creation of conditions, initial values, and limit values applicable to the truck delivery planning problem in response to user operation, and the condition creating module 42 may create conditions, initial values, and limit values based on the input information.

Although it has been explained here that the conditions, initial values, and limit values are created, if the range of searching for a solution to the truck delivery planning problem (facility planning problem) can be reduced as described later, at least one of the conditions, initial values, and limit values may be omitted.

The solution seeking module 43 seeks to solve the truck delivery planning problem (facility planning problem) to which the conditions, initial values and limit values created in step S16 have been added (step S17). As a result, for example, compared to the case where the truck delivery plan problem input in step S11 is solved as it is, it is possible to reduce the range in which the solution is searched, and reduce the time required for seeking the solution (i.e., perform solution seeking at high speed).

Note that, in a case where the processing of step S17 is executed, a truck delivery plan (facility plan) is created, and the output module 5 outputs the truck delivery plan (step S18).

Here, the truck delivery plan (i.e., the solution to the truck delivery planning problem) includes the suitability of borrowing each truck and the operation plan of the truck (e.g., a route to be traveled by the truck, etc.). In this case, the suitability of borrowing each truck is output by the facility selection output module 51, and the operation plan of the truck is output by the operation plan output module 52.

Note that, in the second application example, a plurality of partial problems are repeatedly created while subtracting consumed resources; however, in a case where the facilities are not identical, the obtained results (solutions to the facility planning problem) will differ depending on the order in which the plurality of partial problems are sought to be solved. Therefore, the second application example is suitable for seeking to solve facility planning problems in which the facilities are identical or the priority of the facilities is fixed.

As described above, in the present embodiment, a partial problem is created by selecting any (appropriate) facility from a plurality of facilities and replacing the plurality of facilities in a facility planning problem for creating a facility plan for operating the selected facility with some facilities from among the plurality of facilities. Conditions applicable to the facility planning problem are created based on the solution of the created partial problem, and a facility plan is created by seeking to solve the facility planning problem to which the created conditions have been added.

In the present embodiment, with such a configuration, it is possible to limit the range of searching for the solution of the facility planning problem by adding conditions to the facility planning problem (original problem). Therefore, it is possible to accelerate the creation of the facility plan (i.e., solution seeking of the facility planning problem).

Note that, in the present embodiment, in a case where the facility planning problem includes facility resource information or operation resource information, a plurality of partial problems are created that reflect resources consumed by the sequential selection or operation of a plurality of facilities. In the present embodiment, with such a configuration, it is also possible to create an appropriate facility plan that considers the resources to be consumed.

Furthermore, in the present embodiment, initial values and limit values applied to the facility planning problem are created based on the solution of the partial problems. In the present embodiment, by adding such initial and limit values, the range in which the solution of the facility planning problem is searched can be further limited, and thus the creation of the facility plan can be further accelerated.

In addition, in the present embodiment, in a case where the facility planning problem includes a plurality of pieces of facility information, the facility planning problem may be sought to be solved for each piece of the facility information. Similarly, in a case where the facility planning problem includes a plurality of pieces of operation information, the facility planning problem may be sought to be solved for each piece of the operation information. According to such a configuration, it is possible to obtain (output) the suitability of facilities based on a plurality of solutions and the statistics thereof, etc.

Furthermore, in the present embodiment, the facility planning problem may include partial set information, and the partial set problem may be created based on the partial set information. The partial set information may also include facility ranking information indicating the priority of each partial set. According to this configuration, it is possible to create a partial problem by selecting an appropriate partial set from a plurality of sets of facilities (original sets) in the facility planning problem, thus making it possible to create a highly accurate facility plan.

In addition, in the present embodiment, condition information, evaluation function information, facility information, or operation information included in the facility planning problem may be output, and a partial problem may be created based on information related to the creation of a partial problem input in response to user operation based on the output condition information, evaluation function information, facility information, or operation information (i.e., user operation performed after confirming the information). Furthermore, in the present embodiment, information related to the solution to the partial problem (the solution to the partial problem and the evaluation value in the partial problem) may be output, and conditions may be created based on information related to the creation of conditions applicable to a facility planning problem input in response to user operation based on the information related to the output solution to the partial problem (i.e., user operation performed after confirming the information). According to such a configuration, partial problems and conditions can be created interactively with the user.

In addition, in the present embodiment, a facility to be selected from a plurality of facilities included in the facility plan created by seeking solution to a facility planning problem is output. In the present embodiment, such a configuration enables a user to easily grasp the facility to be selected from among the plurality of facilities in the facility planning problem. Note that, in addition to the facility to be selected from among the plurality of facilities, an operation plan for the facility may also be output.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

With regard to the above-described embodiments, the following supplementary notes are further described.

(1)

An information processing apparatus including a processor configured to:
create, by replacing a plurality of facilities with some of the plurality of facilities in a facility planning problem for creating a facility plan for operating any facility selected from the plurality of facilities, a partial problem of the facility planning problem,
create a condition to be applied to the facility planning problem based on a solution to the created partial problem, and
create the facility plan by seeking to solve a facility planning problem to which the created condition is added.
   (2)

The information processing apparatus of item (1), wherein
the facility planning problem includes facility resource information related to resources consumed by selecting each of the plurality of facilities, and
in a case where the facility planning problem includes the facility resource information, the processor is configured to create a plurality of partial problems reflecting resources consumed by sequential selection of the plurality of facilities based on the facility resource information.
   (3)

The information processing apparatus of item (1) or (2), wherein
the facility planning problem includes operation resource information related to resources consumed by operating each of the plurality of facilities, and
in a case where the facility planning problem includes the operation resource information, the processor is configured to create a plurality of partial problems reflecting resources consumed by sequential operation of the plurality of facilities based on the operation resource information.
   (4)

The information processing apparatus of any one of items (1) to (3), wherein the processor is configured to create an initial value to be applied to the facility planning problem based on the solution of the partial problem, and seek to solve a facility planning problem to which the created initial value is added.

(5)

The information processing apparatus of any one of items (1) to (4), wherein
the facility planning problem includes evaluation function information indicating an evaluation function for obtaining an evaluation value in a case where each
of the plurality of facilities is selected, and the processor is configured to create a limit value of the evaluation value to be applied to the facility planning problem based on the solution of the partial problem, and seek to solve a facility planning problem to which the created limit value is added.
   (6)

The information processing apparatus of any one of items (1) to (5), wherein
the facility planning problem includes a plurality of facility information related to selecting the facility, and
in a case where the facility planning problem includes a plurality of facility information, the facility planning problem is sought to be solved for each of the facility information.
   (7)

The information processing apparatus of any one of items (1) to (6), wherein
the facility planning problem includes a plurality of operation information related to operating the facility, and
in a case where the facility planning problem includes a plurality of operation information, the facility planning problem is sought to be solved for each of the operation information.
   (8)

The information processing apparatus of any one of items (1) to (7), wherein
the facility planning problem includes partial set information related to a partial set representing some of the plurality of facilities, and
the processor is configured to create the partial set problem based on the partial set information.
   (9)

The information processing apparatus of item (8), wherein the partial set information includes facility ranking information indicating a priority order for each of the partial set.

(10)

The information processing apparatus of any one of items (1) to (9), wherein
the facility planning problem includes condition information indicating constraint conditions of the facility planning problem, evaluation function information indicating an evaluation function for obtaining an evaluation value in a case where each of the plurality of facilities is selected, facility information related to selecting the facility, or operation information related to operating the facility, and
the processor is configured to output the condition information, the evaluation function information, the facility information, or the operation information, and create the partial problem based on information related to creating the partial problem input in response to user operation based on the output condition information, evaluation function information, facility information, or operation information.
   (11)

The information processing apparatus of any one of items (1) to (10), wherein the processor is configured to output information related to the solution of the partial problem, and create the condition based on information related to creating the condition input in response to user operation based on the output information related to the solution of the partial problem.

(12)

The information processing apparatus of any one of items (1) to (11), wherein
the created facility plan includes a facility to be selected from the plurality of facilities, and
the processor is configured to output a facility to be selected from the plurality of facilities included in the created facility planning problem.
   (13)

An information processing method including:
creating, by replacing a plurality of facilities with some of the plurality of facilities in a facility planning problem for creating a facility plan for operating any facility selected from the plurality of facilities, a partial problem of the facility planning problem;
creating a condition to be applied to the facility planning problem based on a solution to the created partial problem; and
creating the facility plan by seeking to solve a facility planning problem to which the created condition is added.
   (14)

A non-transitory computer-readable storage medium having stored thereon a program which is executed by a computer, the program including instructions capable of causing the computer to execute functions of:
creating, by replacing a plurality of facilities with some of the plurality of facilities in a facility planning problem for creating a facility plan for operating any facility from the plurality of facilities, a partial problem of the facility planning problem;
creating a condition to be applied to the facility planning problem based on a solution to the created partial problem; and
creating the facility plan by seeking to solve a facility planning problem to which the created condition is added.

What is claimed is:

1. An information processing apparatus comprising a processor configured to:
create, by replacing a plurality of facilities with some of the plurality of facilities in a facility planning problem for creating a facility plan for operating any facility selected from the plurality of facilities, a partial problem of the facility planning problem,
create a condition to be applied to the facility planning problem based on a solution to the created partial problem, and
create the facility plan by seeking to solve a facility planning problem to which the created condition is added.

2. The information processing apparatus of claim 1, wherein
the facility planning problem includes facility resource information related to resources consumed by selecting each of the plurality of facilities, and
in a case where the facility planning problem includes the facility resource information, the processor is configured to create a plurality of partial problems reflecting resources consumed by sequential selection of the plurality of facilities based on the facility resource information.

3. The information processing apparatus of claim 1, wherein
the facility planning problem includes operation resource information related to resources consumed by operating each of the plurality of facilities, and
in a case where the facility planning problem includes the operation resource information, the processor is configured to create a plurality of partial problems reflecting resources consumed by sequential operation of the plurality of facilities based on the operation resource information.

4. The information processing apparatus of claim 1, wherein the processor is configured to create an initial value to be applied to the facility planning problem based on the solution of the partial problem, and seek to solve a facility planning problem to which the created initial value is added.

5. The information processing apparatus of claim 1, wherein
the facility planning problem includes evaluation function information indicating an evaluation function for obtaining an evaluation value in a case where each of the plurality of facilities is selected, and
the processor is configured to create a limit value of the evaluation value to be applied to the facility planning problem based on the solution of the partial problem, and seek to solve a facility planning problem to which the created limit value is added.

6. The information processing apparatus of claim 1, wherein
the facility planning problem includes a plurality of facility information related to selecting the facility, and
in a case where the facility planning problem includes a plurality of facility information, the facility planning problem is sought to be solved for each of the facility information.

7. The information processing apparatus of claim 1, wherein
the facility planning problem includes a plurality of operation information related to operating the facility, and
in a case where the facility planning problem includes a plurality of operation information, the facility planning problem is sought to be solved for each of the operation information.

8. The information processing apparatus of claim 1, wherein
the facility planning problem includes partial set information related to a partial set representing some of the plurality of facilities, and
the processor is configured to create the partial set problem based on the partial set information.

9. The information processing apparatus of claim 8, wherein the partial set information includes facility ranking information indicating a priority order for each of the partial set.

10. The information processing apparatus of claim 1, wherein
the facility planning problem includes condition information indicating constraint conditions of the facility planning problem, evaluation function information indicating an evaluation function for obtaining an evaluation value in a case where each of the plurality of facilities is selected, facility information related to selecting the facility, or operation information related to operating the facility, and
the processor is configured to output the condition information, the evaluation function information, the facility information, or the operation information, and create the partial problem based on information related to creating the partial problem input in response to user operation based on the output condition information, evaluation function information, facility information, or operation information.

11. The information processing apparatus of claim 1, wherein the processor is configured to output information related to the solution of the partial problem, and create the condition based on information related to creating the condition input in response to user operation based on the output information related to the solution of the partial problem.

12. The information processing apparatus of claim 1, wherein
the created facility plan includes a facility to be selected from the plurality of facilities, and
the processor is configured to output a facility to be selected from the plurality of facilities included in the created facility planning problem.

13. An information processing method comprising:
creating, by replacing a plurality of facilities with some of the plurality of facilities in a facility planning problem for creating a facility plan for operating any facility selected from the plurality of facilities, a partial problem of the facility planning problem;
creating a condition to be applied to the facility planning problem based on a solution to the created partial problem; and
creating the facility plan by seeking to solve a facility planning problem to which the created condition is added.

14. A non-transitory computer-readable storage medium having stored thereon a program which is executed by a computer, the program comprising instructions capable of causing the computer to execute functions of:
creating, by replacing a plurality of facilities with some of the plurality of facilities in a facility planning problem for creating a facility plan for operating any facility from the plurality of facilities, a partial problem of the facility planning problem;
creating a condition to be applied to the facility planning problem based on a solution to the created partial problem; and
creating the facility plan by seeking to solve a facility planning problem to which the created condition is added.
